(19) United States
(12) Patent Application Publication
(10) Pub. No.: US 2006/0196329 A1
(43) Pub. Date: Sep. 7, 2006

(54) Method and die for punching or forming

(76) Inventors: Joerg Klimczak I, Leamington (DE); Rainer Kueck, Koeln (DE); Juergen Schueler, Pulheim (DE)

Correspondence Address: FORD GLOBAL TECHNOLOGIES, LLC., FAIRLANE PLAZA SOUTH, SUITE 800, 330 TOWN CENTER DRIVE, DEARBORN, MI, 48126, US

(21) Appl. No.: 11/217,756

(22) Filed: Sep. 1, 2005

(30) Foreign Application Priority Data
Sep. 2, 2004 (EP) 04104224.3

(51) Int. Cl. B26D 1/00

(52) U.S. Cl. 83/13

(57) ABSTRACT

A method and a corresponding tool are disclosed for stamping or forming, by means of a high-speed press, parts from blanks, the parts having at least first and second perforations. The method comprises the steps of performing a first perforating operation to form a center hole in the blank and performing a subsequent perforating operation to form spokes in the blank. The spokes are radially disposed around the center hole and formed while the blank is held in position during the first perforating operation. The blank is held by the perforating tool for the subsequent perforating operation.

### TECHNICAL FIELD OF THE INVENTION

The invention relates to a method of stamping or forming, by means of a high-speed press, parts from blanks, the parts having at least first and second perforations and to a corresponding tool for forming such perforations in the parts.

### DESCRIPTION OF THE BACKGROUND ART

Parts which are produced in large numbers, for example for the automobile industry, are produced in efficient production processes by stamping, forming or forging on fully automatic multistage high-speed presses, which work, for example, at 70 strokes per minute. Such parts are, for example, gears or speed gears for transmissions.

In a conventional forging process, bar material is inductively heated and then hot-sheared in the machine for producing a blank. The actual setting and shaping or forging of the blank is then done in the forging press. Finally, to finish the parts, the perforations are produced by punching out or stamping by means of suitable perforating tools. To complete speed gears, for example, the center hole is punched out in this case. This last step of the perforating or stamping for producing the perforated parts causes difficulties in particular in the case of repeatedly perforated parts.

During the simultaneous perforating of all the regions of the parts which are to be punched out, there is the risk of clogging of the discharge hopper or hoppers of the press due to the large quantity of punched-out material. A further problem lies in the fact that the parts to be produced tend to deform during the simultaneous perforating or stamping of all the regions to be punched out. The parts also tend to turn or be displaced in the die of the press during the perforating, a factor which leads to damage to the parts, such as, for example, to the die-side impression of the speed gears.

Furthermore, burrs must not occur during the perforating or stamping, since these burrs would necessitate rework of the parts. These difficulties occur repeatedly if parts, for example for reducing weight or saving material, are perforated repeatedly, as is effected, for example, in speed gears by forming spokes. In theory, such repeatedly perforated parts could certainly be produced by subsequent machining or chipless processing, but this would be expensive and would not be justifiable economically for large quantities.

### SUMMARY OF THE INVENTION

The present invention provides a method and a tool for stamping or forming perforated parts which permits the automatic production of parts in large quantities without the above disadvantages and without burrs or clogging of discharge hoppers of the press.

This is achieved by the method of the present invention by providing a perforating step, in which the part is perforated by means of at least one perforating tool, having at least two operations. In the present method, only some of the total number of perforations to be made are made during each operation so that the already-perforated part is not present until the last operation has been completed. The part is held in position during the first perforating operation by the perforating tool for the subsequent perforating operation. To this end, a center hole is preferably punched out during the first operation. Spokes are then punched out during the subsequent perforation operation.

In the method according to the invention, the part is held in position during the first perforating operation by force, in particular a spring force, being applied to it by the perforating tool for the subsequent perforating operation. By the part being held in position or retained, rotation or displacement during the perforating is prevented. Rotation or displacement, for example, could result in damage to the die-side impression of the speed gear.

According to the invention, the perforating tool, after completion of the first perforating operation, strikes a stop after overcoming the force and thus initiates the subsequent perforating operation. One perforating tool is advantageously used during the first perforating operation and the subsequent perforating operation. In an embodiment of the invention, the perforating tool comprises two perforating punches for this purpose, so that the perforating tool perforates the part by a first perforating punch during the first perforating operation and by a second perforating punch during the subsequent perforating operation.

The invention also comprises a corresponding tool for stamping or forming by means of a high-speed press, in particular a high-speed forging press, parts from blanks, in particular according to the method of the present invention. The tool includes at least one first perforating punch for producing first perforations in the part and at least one second perforating punch for producing second perforations in the part, both of which are arranged on a perforating-punch holder. The perforating-punch holder is designed in such a way that the first perforating punch perforates the part during a first operation and the second perforating punch perforates the part during a subsequent operation, the second perforating punch bearing against the part and holding it in position during the first operation.

The second perforating punch advantageously has an elastic force element, in particular a spring-force element, which acts in the pressing direction and on the perforating punch in order to hold the part in position during the first operation. The first perforating punch, during the perforating, overcomes the force acting on the second perforating punch, and perforates the part before it has completely overcome the force.

The first perforating punch is advantageously secured to the perforating-punch holder, and the perforating-punch holder has an aperture for accommodating the second perforating punch, in which the latter is displaceably mounted in the pressing direction. The perforating punch is preloaded in the aperature in the pressing direction against a stop by means of the elastic force element.

The second perforating punch projects from the perforating-punch holder in the pressing direction toward the part to be perforated to a greater extent than the first perforating punch, the idle state of the tool being taken as a basis. Furthermore, the tool can be designed in such a way that the second perforating punch secures the part during the first operation during the lowering of the tool by being acted upon by force in such a way as to bear against the part. The trailing first perforating punch perforates the part while at least partly overcoming the force and the second perforating punch is subsequently secured by the stop after completely overcoming the force and then perforates the part.

### BRIEF DESCRIPTION OF THE DRAWINGS

Further features, properties and advantages of the invention follow from the description below with reference to the drawing, in which:

FIG. 1 shows a spoked speed gear produced by means of the method and tool according to the invention, in a perspective view obliquely from above, and

FIG. 2 shows a perspective view of a tool according to the invention obliquely from above, the perforating-punch holder being depicted transparently (in broken lines).

### DETAILED DESCRIPTION OF THE PREFERRED EMBODIMENTS

The method according to the present invention permits the production of circular parts, for example gears, and preferably speed gears having spokes which are repeatedly perforated and otherwise tend to become distorted during the perforating. The production of such parts, in particular spoked speed gears for the automobile industry, is of great interest, since, in addition to the weight reduction and material saving, a reduction in the centrifugal mass is also obtained, which results in a better response behavior of the assembly into which the gear is placed, such as a transmission. Thus, in addition to saving weight and fuel, the construction of the transmission, e.g. in the synchronizing unit, can be simplified.

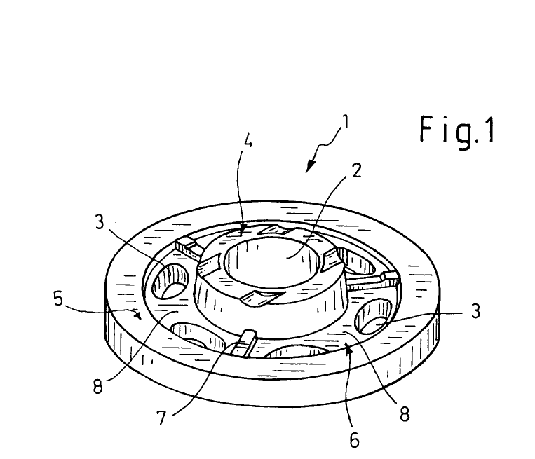

FIG. 1 shows a spoked speed gear produced by means of the method and tool according to the invention, in a perspective view obliquely from above, this speed gear being designated overall by reference numeral 1. The speed gear 1 has two different types of perforation, namely a center hole 2 and perforations 3 producing six spokes 8. The center hole 2 is surrounded by an encircling cylindrical collar 4 which rises from a surface 6 arranged concentrically around the center hole 2. Arranged around the surface 6 is an encircling rim 5, having an encircling end face upon which the teeth (not shown) of the speed gear 1 are provided. In this case, the plane of the surface 6 is offset from plane of the rim 5, so that it lies deeper in the view shown in FIG. 1.

The perforations 3 producing six spokes 8 have an oval form and are arranged in an equally spaced manner concentrically around the center hole 2 in the surface 6 between the collar 4 and the rim 5. Here, two perforations 3 are in each case combined in pairs, so that three regions separated from one another by webs 7 are produced in the surface 6. The three webs 7 run radially from the rim 5 in the direction of the center hole 2 and merge into the collar 4.

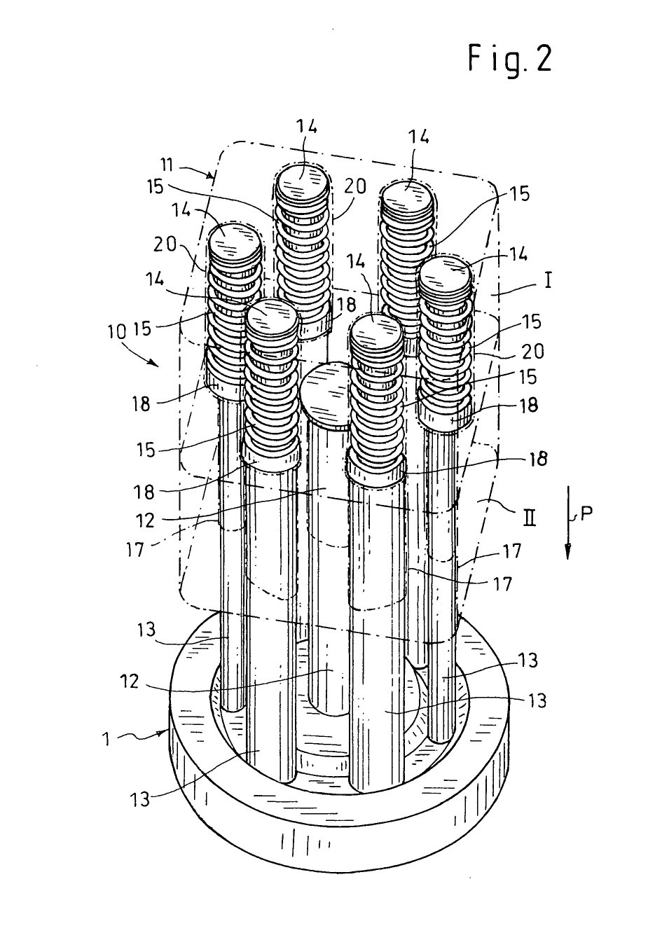

Using the method according to the invention, the speed gear 1 depicted in FIG. 1 is produced by a tool 10 (shown in FIG. 2) in a press (not depicted) in which the tool 10 can be positioned centrally over the speed gear 1 or its ready forged blank and can be lowered onto the latter.

The tool 10 comprises a perforating-punch holder 11 of roughly rectangular cross section, which is depicted transparently in FIG. 2 for the sake of clarity and consists of a top part I and a bottom part II, which are releasably but firmly connected to one another by means of suitable measures.

Furthermore, the tool 10 comprises perforating punches 12 and 13 arranged on the perforating-punch holder 11. The perforating punch 12 serves to punch out the center hole 2 and is therefore circular as viewed in cross section. It is fastened centrally to the underside of the top part I of the perforating-punch holder 11 via a thread 16 present there and passes through the bottom part II of the perforating-punch holder 11 in a corresponding hole 19 of round cross section.

The perforating punches 13 are arranged concentrically and in an equally spaced manner around the perforating punch 12 on the perforating-punch holder 11. The punches 13 produce the spokes 8 by punching out perforations 3 producing the spokes.

Accordingly, six perforating punches 13 are provided, which as viewed in cross section have a roughly oval form, which corresponds to the form of the perforations 3. The perforating punches 13 are each arranged in corresponding holes 17 and 20 which pass through the bottom part II and the top part I of the perforating-punch holder 11 in the longitudinal direction or pressing direction P. The holes 17 in the bottom part II of the perforating-punch holder 11 have an oval cross section corresponding to the perforating punches 13.

In contrast thereto, the holes 20 in the top part I of the perforating-punch holder 11 have a circular cross section. In addition, they each have a stop 14 arranged on the top side or the side remote from the speed gear 1. The stops 14 are secured in the respective holes 20 by means of suitable measures, such as threads.

A spring 15 is provided in each of the holes 20 between the stops 14 and the perforating punches 13. Each spring 15 is secured with the respective stop 14 at the top end and secured at the bottom end via a ring 18 in the hole 20 and is connected to the corresponding perforating punch 13. The perforating punches 13 are therefore movably mounted in the holes 20 and 17 in the pressing direction P by the extent of the spring 15. The perforating punches 13 are thus guided by the oval bottom holes 17, whereas the springs 15, for their preloading, are arranged in the round holes 20, where they can be compressed during operation of the tool.

This special configuration of the perforating-punch holder 11 and holes 17 and 20 allows conventional springs of circular cross section to be used, although the perforating punches 13 have an oval contour. Furthermore, the springs cannot escape downward in pressing direction P, since they do not fit into the oval holes 17 of smaller diameter. On the other hand, the perforating punches 13 can be pushed upward into the holes 20, as a result of which the springs 15 are compressed. To prevent the perforating punches 13 from “falling out” through the holes 17, the punches are widened and thus secured at their top end by means of the circular ring 18.

Because the perforating-punch holder 11 is divided into two parts, it can be produced and adapted to different conditions in a simpler manner.

For perforating a work piece such as a speed gear, the press is lowered until the tool 10 bears against the speed gear 1 merely with the perforating punches 13 which project further from the perforating-punch holder 11 in pressing direction P toward the speed gear 1. This is the initial state of the method or of the tool during the lowering of the press. In this case, “lowering” refers to the closing movement of the press. The position of the press may be both horizontal and vertical, that the speed gear 1 may be arranged above or below the tool 10 and that either the speed gear 1 or the tool 10 is moved during the press operation.

If the press is lowered further in the direction of the speed gear, the perforating punches 13 are each partly pushed into the holes 20 against the spring force of the spring 15 until the central perforating punch 12 bears against the speed gear, the perforating punches 13 being guided in the holes 17. In this state, the spring-preloaded spoke-perforating punches 13 hold the speed gear 1 in its position in the die (not depicted).

The press is thereupon lowered further in the direction of the speed gear and the center hole 2 is punched out by the trailing perforating punch 12, in the course of which the perforating punches 13 continue to be pushed into the holes 20 against the spring force of the springs 15. If the center hole 2 has been perforated and the center-hole slug discharged, the springs 15 are completely compressed, i.e. the perforating punches 13 are pushed into the holes 20 to the maximum extent and in each case strike the fixed stop 14 or the springs 15 are compressed to the maximum extent. In this configuration, the punches are now pressed downward together with the tool 10 or perforating-punch holder 11 in pressing direction P and the spokes 8 are perforated or the perforations 3 producing the spokes are punched.

The speed gear 1, now perforated and ready for the next manufacturing operation, is ejected from the rising press and the next speed gear blank is inserted for perforating. The quantity of punched-out material to be discharged per operation is therefore reduced, so that the discharge hopper or hoppers of the press are not clogged. Furthermore, by the parts being held in position during the first operation, this ensures that the parts do not become distorted and are not displaced during the perforating and furthermore no burrs are produced at the margins of the punched-out regions. Thus rework of the parts is not necessary, despite the use of a conventional high-speed forging press, which works, for example, at 70 strokes per minute and thus permits the efficient production of a large quantity of parts.

For the sake of simplicity, the perforating punches have been described above in the singular. However, it goes without saying that a plurality of perforating punches (of each type) may be provided, as required by the configuration of the part, without departing from the invention. Furthermore, parts of regular or asymmetrical design can be produced using the method according to the invention, if a plurality of holes has to be made in the part.

What is claimed is:

1. A method of forming a part from a blank, the part having at least a first and a second perforation, comprising the steps:
perforating the part with at least one perforating tool, including the steps of:
performing a first perforating operation to form a center hole in the blank; and
performing a subsequent perforating operation to form spokes in the blank, the spokes being radially disposed around the center hole and formed while the blank is held in position during the first perforating operation, the blank being held by the perforating tool for the subsequent perforating operation.

2. The method as claimed in claim 1, wherein the part is held in position during the first perforating operation by a spring force being applied to it by the perforating tool for the subsequent perforating operation.

3. The method as claimed in claim 2, wherein the perforating tool, after completion of the first perforating operation, strikes a stop after overcoming the force and thus initiates the subsequent perforating operation.

4. The method as claimed in claim 1, wherein one perforating tool is used during the first perforating operation and the subsequent perforating operation.

5. The method as claimed in claim 1, wherein the perforating tool perforates the part by a first perforating punch during the first perforating operation and by a second perforating punch during the subsequent perforating operation.

6. The method as claimed in claim 5, wherein the first perforating punch, during the first perforating operation, overcomes a force which acts on the second perforating punch and with which the latter holds the part in position.

7. The method as claimed in claim 6, wherein circular parts are produced.

8. The method as claimed in claim 7, wherein gears are produced.

9. The method as claimed in claim 8, wherein the gears are produced with spokes.

10. The method as claimed in claim 5, wherein a center hole is punched out during the first perforating operation.

11. The method as claimed in claim 10, wherein spokes are punched out during the subsequent perforating operation.

12. A tool for forming by means of a high-speed press, parts from blanks, comprising:
at least one first perforating punch for producing first perforations in the part;
at least one second perforating punch for producing second perforations in the part which are arranged on a perforating-punch holder; and
wherein the perforating-punch holder is designed such that the first perforating punch perforates the part during a first operation and the second perforating punch perforates the part during a subsequent operation, the second perforating punch bearing against the part and holding it in position during the first operation.

13. The tool as claimed in claim 12, wherein the second perforating punch has an elastic force element which acts in the pressing direction and on the perforating punch in order to hold the part in position during the first operation.

14. The tool as claimed in claim 13, wherein the first perforating punch is operative to overcome the force acting on the second perforating punch such that the first perforating punch perforates the part before it has completely overcome the force.

15. The tool as claimed in claim 14, wherein the first perforating punch is secured to the perforating-punch holder, and the perforating-punch holder includes an aperture for receiving the second perforating punch.

16. The tool as claimed in claim 15, wherein the perforating punch is preloaded in the aperture in the pressing direction against a stop by the elastic force element.

17. The tool as claimed in claim 16, wherein the second perforating punch projects from the perforating-punch holder in the pressing direction toward the part to be perforated to a greater extent than the first perforating punch.

18. The tool as claimed in claim 12, wherein the perforating-punch holder consists of two parts.
